(19) United States
(12) Patent Application Publication
(10) Pub. No.: US 2003/0145738 A1
(43) Pub. Date: Aug. 7, 2003

(54) Oat crimping device

(76) Inventors: Jim R. Bowen, Dubach, LA (US); Oliver W. Skipper, Ruston, LA (US)

Correspondence Address: John M. Harrison, 2139 E. Bert Kouns, Shreveport, LA, 71105, US

(21) Appl. No.: 10/357,576

(22) Filed: Feb. 4, 2003

Related U.S. Application Data
(60) Provisional application No. 60/355,483, filed on Feb. 6, 2002.

(51) Int. Cl. A23L 1/00

(52) U.S. Cl. 99/353; 99/349

(57) ABSTRACT

An oat crimping device which is characterized by a housing fitted with a feed barrel and including a hopper located inside the housing for receiving raw oats to be crimped or processed. A pair of rotating, knurled drums are provided in the hopper and raw oats are fed from the feed barrel through top slots or openings in a feed auger tube to a rotating feed auger inside the feed auger tube, which feed auger distributes the raw oats through bottom slots in the feed auger tube, to the rotating drums for dispensing through the lower portion of the hopper into a collection container. Manual adjustment of the raw oat feed stream is accomplished by rotation of the feed auger tube to adjust the slots for dispensing the raw oats from the feed barrel to the feed auger crimping rollers.

### CROSS-REFERENCE TO RELATED APPLICATIONS

This application claims the benefit of and incorporates by reference prior filed copending U.S. Provisional Application Serial No. 60/355,483 filed Feb. 6, 2002.

### BACKGROUND OF THE INVENTION

1. Field of the Invention

This invention relates to the processing of oats and more particularly, to an oat crimping device for crimping oats, which device is characterized by a housing fitted with an internal hopper containing a pair of crimping rollers located in close proximity to each other and a feed mechanism for feeding raw oats from the feed barrel or container to the crimping rollers and then to a collecting container such as a bucket. The feed mechanism includes a feed auger tube having longitudinal, diametrically oppositely-disposed feed slots and enclosing a rotating, spiralled feed auger. The feed auger tube can be manipulated in an arc by means of a handle to align the upper feed slots with a corresponding slot defined by the hopper feed plates and dispense raw oats through the upper feed slots onto the feed auger tube and from the feed auger tube through the lower feed slots, to the rotating crimping rollers. The device is typically driven by an electric motor which operates one of the crimping rollers as the drive roller and also drives the feed auger by means of a belt. The drive roller and idler roller are connected by gears to facilitate rotation at the same speed. Adjustment of the raw oat feed stock flow from the feed barrel to the feed auger tube is accomplished by grasping a collar handle attached to the feed auger tube and aligning the auger feed slots with the feed slot in the hopper to facilitate a smooth gravity flow of raw oats through the upper feed slots to the rotating feed auger and from the feed auger in a more even spiralled distribution, through the bottom feed slots in the feed auger tube to the crimping rollers.

2. Description of the Prior Art

Various types of oat processing equipment to make the oats edible for animals such as horses, are known on the art. Typical of these is the “ROLLEM” precision oat crimper and corn crusher. The ROLLEM device includes a hopper for receiving the raw oats and a processing or crimping unit for crimping the raw oats into a more easily digestible product.

It is an object of this invention to provide a new and improved oat crimping device which includes a pair of rotating crimping drums fed by a feed auger tube fitted with feed slots and enclosing a rotating feed auger, such that raw oats are fed to the feed auger by rotary operation of the feed auger tube and from the feed auger to the crimping rollers for processing.

Another object of this invention is to provide a new and improved oat crimping device which is characterized by a feed barrel mounted on an enclosure that contains an oat crimping mechanism, which mechanism includes a feed hopper enclosing a top and bottom slotted feed auger tube which houses a rotating feed auger and a pair of crimping rollers rotatably mounted in a roll enclosure extending from the hopper beneath the feed auger, such that oats may be fed from the feed barrel through top longitudinal feed slots in the feed auger tube to the feed auger and from the feed auger through oppositely-disposed, bottom longitudinal feed slots in the feed auger tube to the crimping rollers, responsive to manipulation of a collar handle that rotatably adjusts the feed auger tube through an arc and displaces the feed slots with respect to the feed auger.

Still another object of this invention is to provide a new and improved oat crimping device characterized by a frame typically fitted with removable panels and provided with a feed barrel for containing a supply of raw oats. A feed hopper is located inside the frame beneath the feed barrel and encloses a rotating feed auger positioned inside a feed auger tube having top and bottom feed slots, for selectively receiving raw oats from the feed barrel and feeding the oats through the top feed slots in the feed auger tube, to the feed auger. A pair of rotating crimping drums or rollers is located in a roll enclosure which extends the feed hopper beneath the feed auger and the knurled finishes on the crimping drums are designed to “crimp” the oats as they fall by gravity from the feed auger between the crimping drums and into collection buckets or barrels.

Still another embodiment of the invention is to provide a motor-operated oat crimping device for processing raw oats, which device includes a storage barrel mounted on an enclosure which supports an internal hopper and roll enclosure, the latter of which contains a pair of adjacent, longitudinal, inwardly-rotating crimping rollers, one of which crimping rollers is driven and the other acting as an idler roller. A rotating feed auger is positioned in the hopper above the crimping rollers and the feed auger is encased in a feed auger tube fitted with top and bottom linear feed slots and an adjusting handle. Raw oats contained in the feed barrel may be manually dispensed from an opening in the feed barrel through a feed guide plate slot and then through a top feed slot located in the feed auger tube by manipulation of the handle, to the feed auger, and then by means of the feed auger, through subsequent bottom feed slots in the feed auger tube to the crimping rollers for processing.

### SUMMARY OF THE INVENTION

These and other objects of the invention are provided in a new and improved oat crimping device which is portable, small and capable of crimping oats in large quantities. In a preferred embodiment the oat crimping device is characterized by a frame enclosing a feed hopper for receiving raw oats from a barrel mounted on the top of the frame over the feed hopper, and a roll enclosure including a pair of inwardly turning, longitudinal knurled crimping rollers, one of which crimping rollers is driven by an electric motor and the other of which is geared to the drive crimping roller for rotation at the same speed. A rotatably adjustable feed auger tube is positioned in the feed hopper above the crimping rollers and encloses a spiralled rotating feed auger, also driven by the electric motor, such that feeding of the raw oats from the barrel through top feed slots in the feed auger tube to the feed auger further dispenses the oats evenly through bottom feed slots located in the feed auger tube to the crimping rollers, for processing.

### BRIEF DESCRIPTION OF THE DRAWINGS

The invention will be better understood by reference to the accompanying drawings wherein:

FIG. 1 is a front and right side perspective view of the oat crimping device of this invention;

FIG. 2 is a rear and left side perspective view of the oat crimping device;

FIG. 3 is a front and right side perspective view of the oat crimping device with the front and right side panels removed;

FIG. 4 is a rear and left side perspective view of the oat crimping device with the rear and left side panels removed;

FIG. 5 is a lateral exploded view of the oat crimping device;

FIG. 6 is a sectional view taken along line 6-6 of the internal components of the oat crimping device illustrated in FIG. 5;

FIG. 7 is a vertical exploded view of the internal components of the oat crimping device;

FIG. 8 is a bottom perspective view of a typical feed barrel for containing raw oats;

FIG. 9 is an exploded view of the feed mechanism of the oat crimping device;

FIG. 10 is an exploded view of the feed auger tube and feed auger components of the oat crimping device;

FIG. 11 is a bottom perspective view of the roll enclosure and the crimping rolls in functional position in the roll enclosure;

FIG. 12 is an exploded view of the crimping roller gears, sprocket and pulley configuration; and

FIG. 13 is an enlarged sectional view of the roll enclosure, more particularly illustrating a preferred technique for mounting the roll enclosure on the frame of the oat crimping device.

### DESCRIPTION OF THE PREFERRED EMBODIMENTS

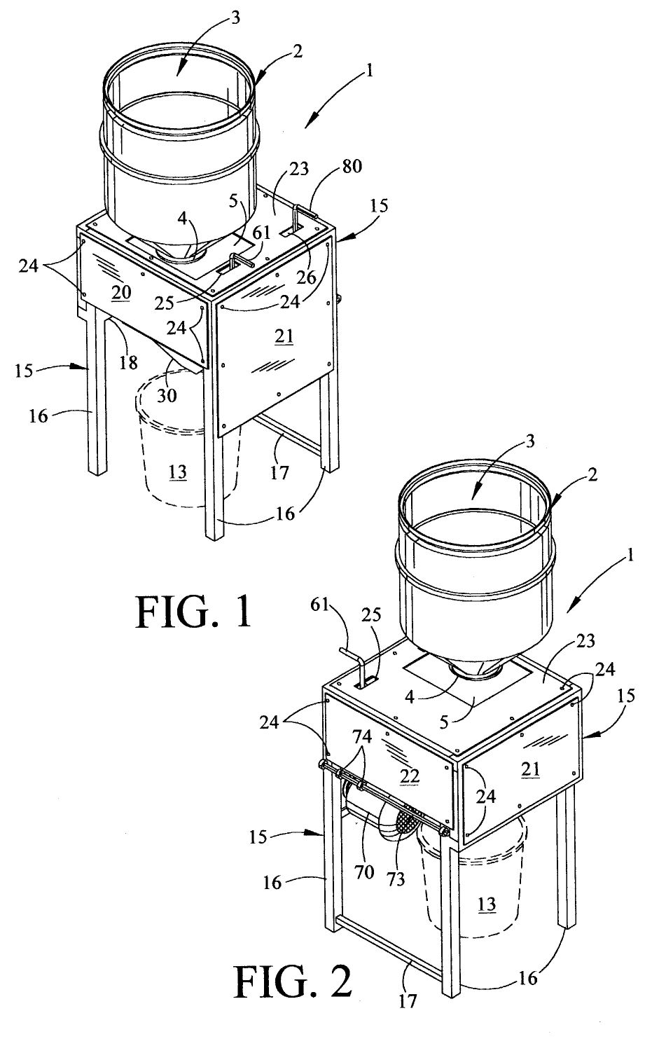

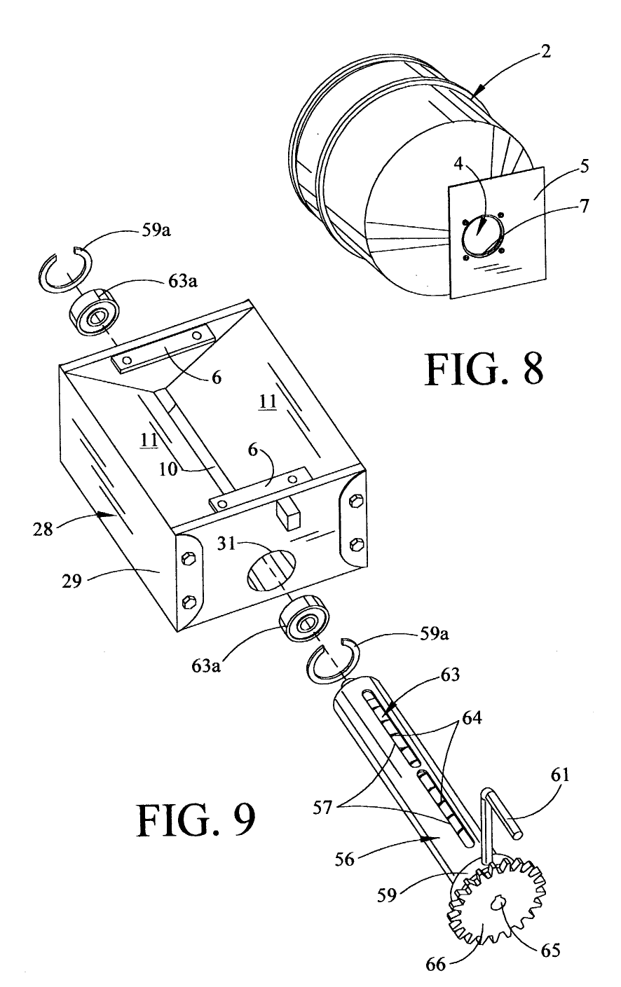

Referring initially to FIGS. 1, 2, 6 and 8 of the drawings, the oat crimping device of this invention is generally illustrated by reference numeral 1. The oat crimping device 1 includes a feed barrel 2, mounted on a frame 15 and fitted with a top barrel opening 3 which communicates with a feed nozzle 4, provided in a nozzle mount plate 5, as particularly illustrated in FIGS. 6 and 8. A pair of mount plate brackets 6 (FIG. 9) are provided on the top of the frame 15 to support the nozzle mount plate 5 over the mount plate opening 7 and mount plate bolt openings 8 serve to removably mount the nozzle mount plate 5 and the feed barrel 2 on the frame 15 by means of suitable mount bolts (not illustrated).

As further illustrated in FIG. 9 a pair of feed guide plates 11 are provided on the frame 15 and slant inwardly to define a feed access opening 10 at the bottom thereof. The frame 15 is also fitted with frame legs 16 for elevating the feed barrel 2 to a desired level or height and the side braces 17 and cross braces 18 are provided in the frame 15 to stiffen the frame 15 and support the feed barrel 2 when it is loaded with raw oat product (not illustrated).

Referring again to FIGS. 1 and 2, a front panel 20, side panels 21, rear panel 22 and top panel 23 are removably attached to the frame 15 typically by means of panel screws 24, to access the internal component parts of the oat crimping device 1. A feed auger handle slot 25 is provided in one of the top panel 23 for purposes which will be hereinafter further described.

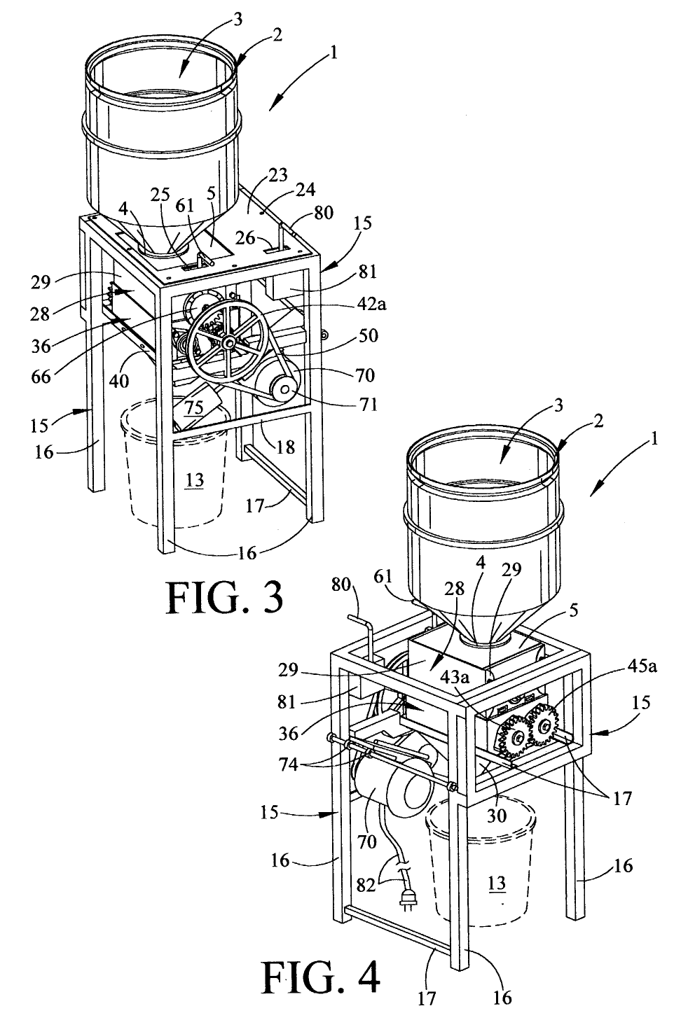

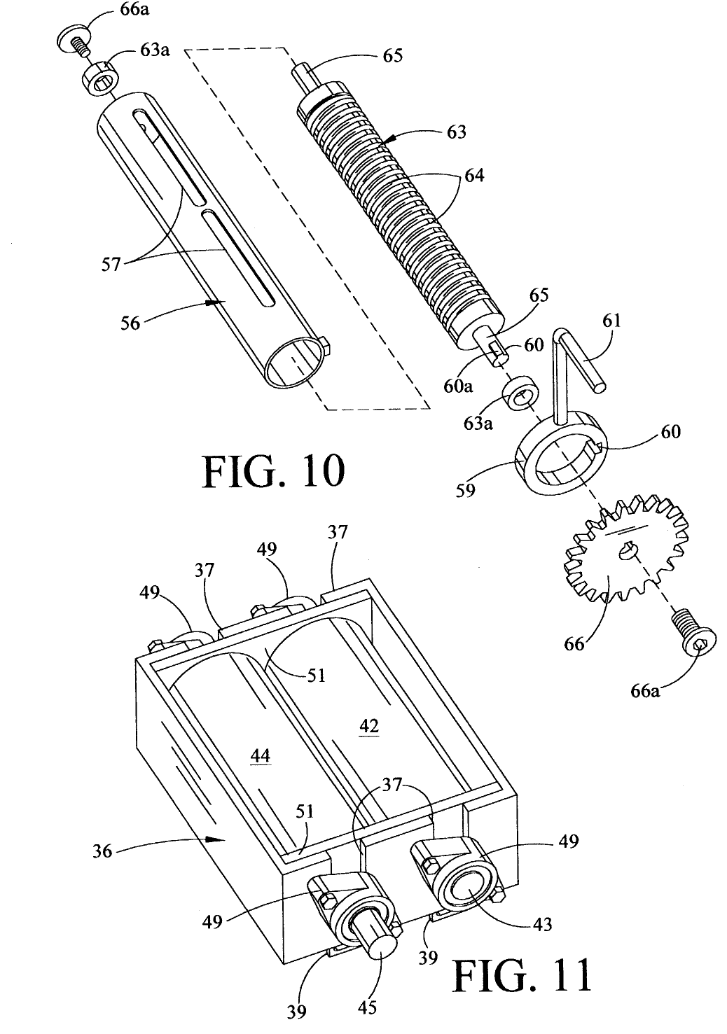

A feed hopper 28 is located inside the frame 15 mounted on the cross braces 18 and includes a hopper top 29 and a tapered hopper bottom 30, as illustrated in FIGS. 3, 4 and 9. A pair of feed auger mount openings 31 are provided in opposite sides of the hopper top 29 (FIG. 9) to accommodate a pair of auger bearings 63a, supporting a rotating feed auger 63, rotating with an auger shaft 65 seated in the auger bearings 63a. The feed auger 63 is provided with spiralled auger grooves 64 (FIG. 10) for evenly dispensing raw oat feed for processing as hereinafter further described. The hopper top 29 of the feed hopper 28 and the tapered hopper bottom 30 are typically mounted on the frame 15 as hereinafter described.

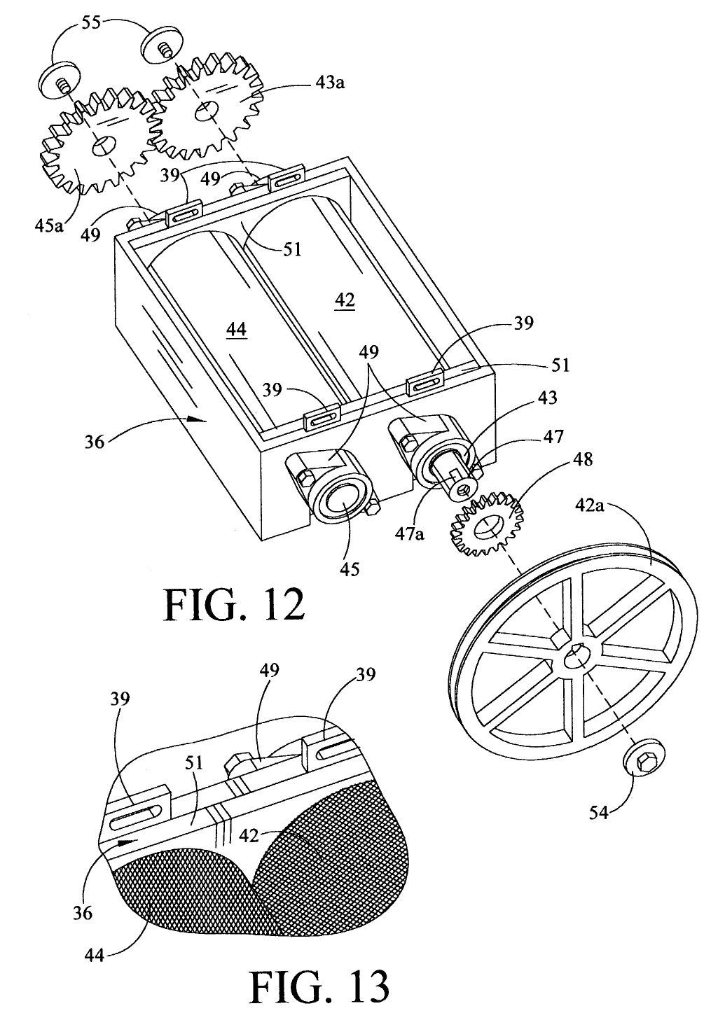

A roll enclosure 36 is provided with mount tabs 39 for mounting on the frame 15 and with oppositely-disposed, facing sets of enclosure key slots 37 and is fitted with enclosure bolts to mount a pair of roll end plates 51, as further illustrated in FIGS. 11 and 12. A horizontally-disposed drive roll 42 is provided with a drive roll shaft 43 for mounting in a pair of aligned roller bearings 49, respectively, each fitted on and bolted to the roll enclosure 36 and the roll end plates 51, as further illustrated in FIG. 11. A horizontally-oriented idler roller 44 is positioned alongside the drive roll 42 and includes an idler roller shaft 45, which is likewise fitted in a pair of the roller bearings 49, located in opposite roll end plates 51. The hopper top 29 is typically seated on the roll enclosure 36, while the hopper bottom 30 is suspended from the roll enclosure 36.

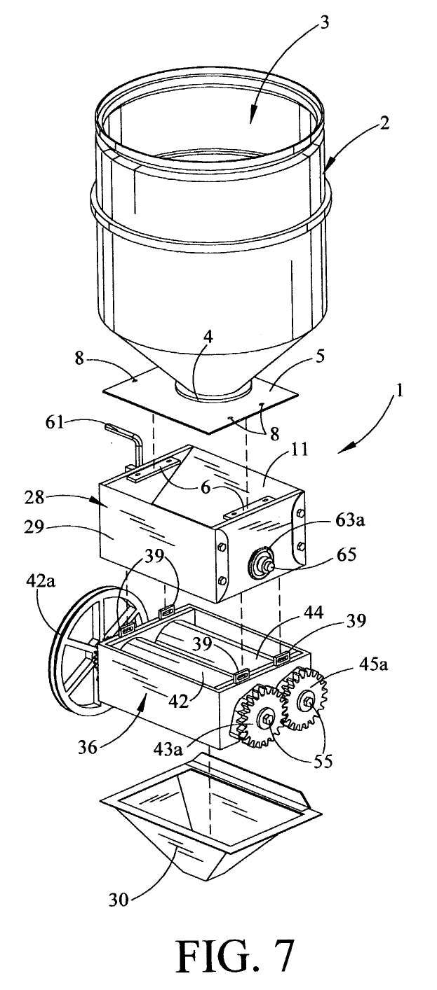

As further illustrated in FIG. 12, a drive roll pulley 42a and a drive roll sprocket 48 are provided on one end of the drive roll shaft 43, the former by means of a pulley mount bolt 54, while a drive roll gear 43a is provided on the opposite end of the drive roll shaft 43, secured by a gear mount bolt 55. Furthermore, an idler roll gear 45a is secured on the opposite end of the idler roll shaft 45 by means of a second gear mount bolt 55 and meshes with the drive roll gear 43a, as illustrated in FIGS. 7 and 12. Roll key slots 47 are also provided in the drive roll shaft 43 and the idler roll shaft 45, respectively, for receiving corresponding roll keys 47a and attaching the respective drive roll pulley 42a and the drive roll gear 43a to the drive roll shaft 43, and the idler roll gear 45a to the idler roll shaft 45. Each of the drive roll 42 and the idler roll 44 are provided with a knurled finish and are disposed horizontally very close to each other, such that raw oats dispensed between the inwardly-rotating rolls process and crimp the oats in a desired fashion into the desired crimped oat product.

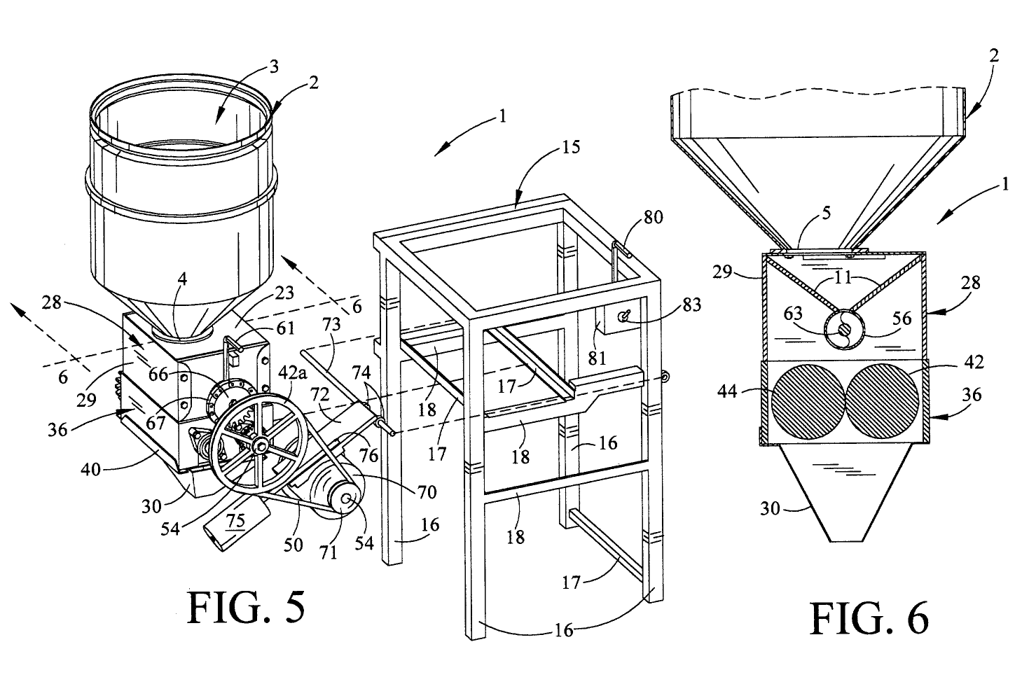

Referring now to FIGS. 9 and 10 of the drawings a feed auger tube 56 is fitted with a tube collar 59, having a collar key slot 60 for seating on the feed auger tube 56 with a collar key (not illustrated). The feed auger tube 56 is mounted on auger bearings 63a, typically by means of collar snap rings 59a and a collar handle 61 is attached to or shaped integrally with the tube collar 59 for manipulating the feed auger tube 56 circumferentially through an arc, as hereinafter described. Longitudinally, diametrically oppositely-disposed feed slots 57 are also provided in the top and bottom of the feed auger tube 56 as illustrated, to facilitate feeding of raw oats from the feed hopper through the feed auger tube and to the spiralled feed auger 63, rotatably disposed inside the feed auger tube 56 by means of the auger shaft 65. Accordingly, the oats are fed through the top set of feed slots 57 to the rotating feed auger 63 and are then evenly dispensed by means of the spiral grooves 64 in feed auger 63, through the bottom set of feed slots 57, as illustrated. The raw oat feed falls by gravity in an even distribution from the bottom set of feed slots 57, between the rotating drive roll 42 and idler roll 44, for crimping and then into the crimped oat bucket 13. A feed auger sprocket 66 is further secured to the auger shaft 65 of the feed auger 63 by means of a feed auger sprocket bolt 66a and the collar key 60a, seated in the collar key slot 60. An endless auger drive chain 67 extends from the feed auger sprocket 66 to the drive roll sprocket 48, for driving the feed auger 63 at the same speed as the drive roll 42, as illustrated in FIG. 5 and as hereinafter further described.

Referring now to FIGS. 3 and 5 of the drawings, a drive motor 70 is fitted with a drive motor pulley 71 that connects to a drive roll pulley 42b on the drive roll 42, by means of a drive belt 50. The drive motor 70 is typically secured to a drive motor base 72, attached to a drive motor rod 73 by a pair of base mount collars 74, and a belt tensioning weight 75 is slidably mounted on a belt tensioning weight rod 76 to facilitate tensioning of the drive belt 50, as desired. Rod set screws 77 serve to mount each base mount collar 74 on the drive motor base rod 73.

Referring to FIGS. 1 and 3 of the drawings, a motor reverse handle 80 is provided on the top of the frame 15 above a motor wiring box 81, and extends through a motor reverse handle slot 26, to facilitate reversal of the drive motor 70 under circumstances where the raw oats feed jams the drive roll 42 and the idler roll 44 during operation of the oat crimping device 1. A power cord 82 serves to connect the drive motor 70 to a source of electric power and is wired into the motor wiring box 81, according to the knowledge of those skilled in the art. An on/off switch 83 (FIG. 5) is provided on the motor wiring box 81 or in the vicinity thereof, for initiating and stopping operation of the drive motor 70.

The oat crimping device 1 of this invention is portable, easily operated and effective to crimp oats into a readily edible and digestible crimped oat product for animals such as horses. The device can also be used to produce a first stage product for consumption by human beings.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. An oat crimping device comprising a frame; a container provided on said frame for containing a supply of oats; a pair of crimping rollers journalled for rotation in said frame beneath said container; and a feed mechanism provided in said frame between said container and said crimping rollers, said feed mechanism disposed for receiving the oats from said container and dispensing the oats to said crimping rollers for crimping the oats.

2. The oat crimping device of claim 1 wherein said feed mechanism comprises an auger tube adjustably mounted on said frame; top feed slots and bottom feed slots provided in said auger tube for selectively receiving the oats from said container through said top feed slots and dispensing the oats to said crimping rollers through said bottom feed slots; and a feed auger rotatably disposed within said auger tube for receiving the oats from said top feed slots and dispensing the oats through said bottom feed slots to said crimping rollers.

3. The oat crimping device of claim 1 comprising a knurled finish provided on said crimping rollers for crimping the oats therebetween.

4. The oat crimping device of claim 2 comprising a drive motor mounted on said frame, said drive motor operably connected to said feed auger and at least one of said crimping rollers for rotatably driving said crimping rollers and said feed auger.

5. The oat crimping device of claim 4 comprising a knurled finish provided on said crimping rollers for crimping the oats therebetween.

6. The oat crimping device of claim 2 comprising a feed hopper attached to said frame, said feed hopper enclosing said auger tube and said feed auger for containing the oats dispensed from said container to said auger tube, said feed auger and said crimping rollers.

7. The oat crimping device of claim 6 comprising a drive motor mounted on said frame, said drive motor operably connected to said feed auger and at least one of said crimping rollers for rotatably driving said crimping rollers and said feed auger.

8. The oat crimping device of claim 7 comprising a knurled finish provided on said crimping rollers for crimping the oats therebetween.

9. An oat crimping device comprising a frame; a container provided on said frame for containing a supply of oats; a pair of crimping rollers journalled for horizontal rotation in said frame beneath said container; an auger tube adjustably mounted on said frame; top feed slots and bottom feed slots provided in said auger tube for selectively receiving the oats from said top feed slots and dispensing the oats through said bottom feed slots to said crimping rollers; and a feed auger rotatably disposed within said auger tube for receiving the oats from said top feed slots and dispensing the oats through said bottom feed slots to said crimping rollers.

10. The oat crimping device of claim 9 comprising a pair of gears connecting said crimping rollers and a drive motor mounted on said frame, said drive motor operably connected to said feed auger and one of said crimping rollers for rotatably driving said crimping rollers and said feed auger.

11. The oat crimping device of claim 9 comprising a feed hopper attached to said frame said feed hopper enclosing said auger tube and said feed auger for containing the oats dispensed from said container to said auger tube, said feed auger and said crimping rollers.

12. The oat crimping device of claim 9 comprising a knurled finish provided on said crimping rollers for crimping the oats therebetween.

13. An oat crimping device comprising a frame; a container provided on said frame for containing a supply of oats; a pair of crimping rollers journalled for horizontal rotation in said frame beneath said container; an auger tube horizontally and adjustably mounted on said frame; top feed slots and bottom feed slots provided in said auger tube for selectively receiving the oats from said top feed slots and dispensing the oats through said bottom feed slots to said crimping rollers; and a feed auger rotatably disposed within said auger tube for receiving the oats from said top feed slots and dispensing the oats in a uniform fashion through said bottom feed slots to said crimping rollers.
